(19) United States
(12) Patent Application Publication
(10) Pub. No.: US 2024/0166076 A1
(43) Pub. Date: May 23, 2024

(54) COORDINATION OF INDICATIONS AT CHARGING DEVICES AND ELECTRIC VEHICLES

(71) Applicant: Rivian IP Holdings, LLC, Plymouth, MI (US)

(72) Inventors: Michael Rosenblatt, Boulder, CO (US); Jeffrey Wei Doong, Redondo Beach, CA (US)

(73) Assignee: Rivian IP Holdings, LLC, Plymouth, MI (US)

(21) Appl. No.: 18/056,448

(22) Filed: Nov. 17, 2022

(51) Int. Cl. B60L 53/66; B60L 53/30

(52) U.S. Cl. CPC B60L 53/66; B60L 53/305; B60L 2250/16

(57) ABSTRACT

At least one aspect is directed to a system. The system can include a data processing system with one or more processors, coupled to memory. The data processing system can detect a charge query to charge a vehicle. The data processing system can determine a presence of the vehicle in an area having a charging device. The data processing system can instruct, in response to the presence of the vehicle in the area, a component of the charging device to output a first presentation indicative of the charge query. The data processing system can instruct, in response to the presence of the vehicle in the area, a component of the vehicle to output a second presentation corresponding to the first presentation.

### INTRODUCTION

Vehicles such as electric vehicles can be powered by batteries. Operation of the vehicle can use power and deplete the batteries.

### SUMMARY

This technical solution is directed to coordination of indications at charging devices and electric vehicles. The technical solution can include coordination of visual, audio, or user interface devices, for example, between charging devices and electric vehicles. The coordination can include identification of particular charging device and a particular electric vehicle, and generation of corresponding or matching output at visual, audio, or user interface devices at particular ones of the charging devices and the electric vehicles. For example, a charging device can output a lighting device integrated therewith with a particular light color, and an electric vehicle can illumination an illumination device, dash light, or interior light integrated therewith with the same light color output by the charging device. Thus, the indications can identify a particular charging device linked to a particular electric vehicle. A link between a charging device and an electric vehicle can include a reservation for the electric vehicle at the charging device at a particular time or time range. The technical solution can include a computing system to coordinate the output of one or more indications output by a particular charging device and a particular electric vehicle.

At least one aspect is directed to a system. The system can include a data processing system with one or more processors, coupled to memory. The data processing system can detect a charge query to charge a vehicle. The data processing system can determine a presence of the vehicle in an area having a charging device. The data processing system can instruct, in response to the presence of the vehicle in the area, a component of the charging device to output a first presentation indicative of the charge query. The data processing system can instruct, in response to the presence of the vehicle in the area, a component of the vehicle to output a second presentation corresponding to the first presentation.

At least one aspect is directed to an electric vehicle. A vehicle can include a light emitting device, a non-transitory memory, and one or more processors to transmit a charge query to charge the vehicle. The vehicle can determine a presence of the vehicle in an area having a charging device.

At least one aspect is directed to a charging device. A charging device can include a light emitting device, a non-transitory memory, and one or more processors to detect a charge query to charge a vehicle. The charging device can determine a presence of the vehicle in an area having the charging device. The charging device can output, by the light-emitting device in response to a determination that a location of the vehicle corresponds to the area, the first presentation.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification. The foregoing information and the following detailed description and drawings include illustrative examples and should not be considered as limiting.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 depicts a system in accordance with present implementations.

FIG. 2 depicts a view of a charging device, in accordance with present implementations.

FIG. 3 depicts a view of a charging device, in accordance with present implementations.

FIG. 4 depicts a charging device having an activated illumination device, in accordance with present implementations.

FIG. 5 depicts a charging device having an activated display device, in accordance with present implementations.

FIG. 6 depicts a charging device having an activated audio device, in accordance with present implementations.

FIG. 7 depicts a charging area in accordance with present implementations.

FIG. 8 depicts a charging area in accordance with present implementations.

FIG. 9 depicts a charging area in accordance with present implementations.

FIG. 10 depicts a charging area in accordance with present implementations.

FIG. 11 depicts a charging area in accordance with present implementations.

FIG. 12 depicts a charging area in accordance with present implementations.

FIG. 13 depicts a charging area in accordance with present implementations.

FIG. 14 depicts an electric vehicle in accordance with present implementations.

FIG. 15 depicts a block diagram illustrating an architecture for a computer system that can be employed to implement elements of the systems and methods described and illustrated herein.

FIG. 16 depicts a method of location-aware and time-aware to coordination of indications at charging devices and electric vehicles, in accordance with present implementations.

FIG. 17 depicts a method of location-aware and time-aware to coordination of indications at charging devices and electric vehicles.

FIG. 18 depicts a method of location-aware and time-aware to coordination of indications at charging devices and electric vehicles.

FIG. 19 depicts a method of location-aware and time-aware to coordination of indications at charging devices and electric vehicles.

FIG. 20 depicts a charging area in accordance with present implementations.

FIG. 21 depicts a charging area in accordance with present implementations.

FIG. 22 depicts a charging area in accordance with present implementations.

### DETAILED DESCRIPTION

Following below are more detailed descriptions of various concepts related to, and implementations of, methods, apparatuses, and systems of location-aware and time-aware to coordination of indications at charging devices and electric vehicles. The various concepts introduced above and discussed in greater detail below may be implemented in any of numerous ways.

Systems and methods described herein can connect electric vehicles with electrical infrastructure. Such connections can be complex due to the increasing number of electric vehicles in operation and the complexity of developing and deploying infrastructure to accommodate those electric vehicles in operation. Connecting particular systems and devices to particular electric vehicles can be blocked or prevented by systems and devices incapable of timely communication and coordination of systems operation between infrastructure and corresponding electric vehicles.

The present disclosure is directed at least to systems and methods of location-aware and time-aware to coordination of indications at charging devices and electric vehicles. This technical solution is generally directed to improving coordination of activation of user interface or lighting hardware functions of a vehicle with one or more charging devices, to reduce navigation errors in operation of the vehicle near particular charging stations. The technical solution can provide one or more human-perceptible indications coordinated between a particular vehicle and a particular charging station, with respect to a particular time or time period. The technical solution can initiate one or more indications at one or more hardware devices of a charging station, in response to user input remote from the charging station and associated with a particular vehicle. The technical solution can include instructing a user interface or a lighting component, for example, of a charging station to perform certain actions or to display certain visual indications at certain times or within certain time periods. A user interface can include, for example, a touchscreen or a video monitor. A lighting component of the charging station can include an LED device or array, for example. The technical solution can include instructing a user interface or lighting components, for example, of a vehicle to perform certain actions or to display certain visual indications or emit certain audio indications at certain times or within certain time periods. The indications generated at the charging station and the vehicle can be coordinated based on time and location. For example, an indication at a vehicle and at a charger may activate or change based on a location of one or more of the charging station, a proximity between the vehicle and the charging station, or any combination thereof.

This technical solution can coordinate indication based on location and time. A computing system can identify a location of a vehicle and a location of or corresponding to a charging device, and can instruct one or more of the charging device and the vehicle to output particular illuminations based on a relative distance or estimated time based on the locations. For example, the computing system can instruct a particular charging device and a particular electric vehicle to respectively output a particular set of coordinated indications based on the vehicle reaching a particular maximum distance from the charging device or entering a geofence including the charging device. The computing system can identify a particular time associated with activation of a charging device at a particular location and a time associated with a location of a particular electric vehicle. For example, a computing system can link a particular charging device to a particular electric vehicle, and can instruct the charging device and the electric vehicle to output coordinated illumination on satisfaction of a condition that a location of the vehicle satisfies a location threshold and a time of satisfaction of the location threshold satisfies a time threshold. For example, a computing system can receive a request to reserve a charging device at a particular charging area at a particular time. In this example, the computing system can instruction the charging device and the electric vehicle to output coordinated indications only if the vehicle arrives at the charging area within an predetermined time of the reservation time. Thus, a technical solution for location-aware and time-aware to coordination of indications at charging devices and electric vehicles is provided.

The charging station can enter a first state in response to receiving a reservation request from a particular vehicle or a user device associated with the particular vehicle. The reservation request can be transmitted remotely from the charging device. The reservation request can include a time or time period during which the particular vehicle can enter a charging session at the charging device to charge a battery of the vehicle. The lighting component can provide a first indication corresponding to the first state. For example, the lighting component can emit a solid red color indicating a reservation of the charging device and that the charging device is only available to a particular vehicle. The user interface can display a text message indicating that the charging device is reserved and that the charging device is only available to a particular vehicle.

The charging device can enter a second state in response to a successful reservation creation linking a vehicle to a charging device, and a location threshold satisfied between the vehicle and the charging device. For example, the charging device emit a color or illumination pattern distinct from that presented in the first state, when a vehicle approaches a location of the charging station. For example, an approach can be detected by a system coupled with the vehicle and the charging device, when the vehicle enters a geofence associated with charging device, or is within a predetermined distance threshold associated with the charging device. The lighting component can provide a second indication corresponding to the second state. For example, the lighting component can emit a solid violet color indicating a reservation of the charging device and that the charging device is only available to a particular approaching vehicle. The user interface can display a text message identifying a characteristic of the particular vehicle or a user of the particular vehicle.

The particular vehicle can emit light color or an illumination pattern corresponding to the light color or illumination pattern of the charging device. For example, the vehicle linked to the charging station can emit a violet color matching that of a violet color emitted by the charging device. The user interface of the vehicle can provide a presentation corresponding to the linked charging device. For example, the charging device can provide navigation toward the particular charging device or can identify the particular charging device on a video display. A color or an illumination pattern can vary based on a distance between the vehicle and the charging device. For example, lighting on one or more of the vehicle and the charging device can brighten, begin or quicken a pulsing or flashing pattern, or any combination thereof, as a distance between the vehicle and the charging device decreases.

Present implementations can include a vehicle communicatively coupleable with a remote server. The remote server can be communicatively coupled with or include one or more systems to obtain a reservation request from a particular vehicle or user linked to a particular vehicle, confirm availability of a request, to instruct the charging device to operate a user interface and lighting components integrated therewith, and to instruct the vehicle to operate a user interface and lighting components integrated therewith.

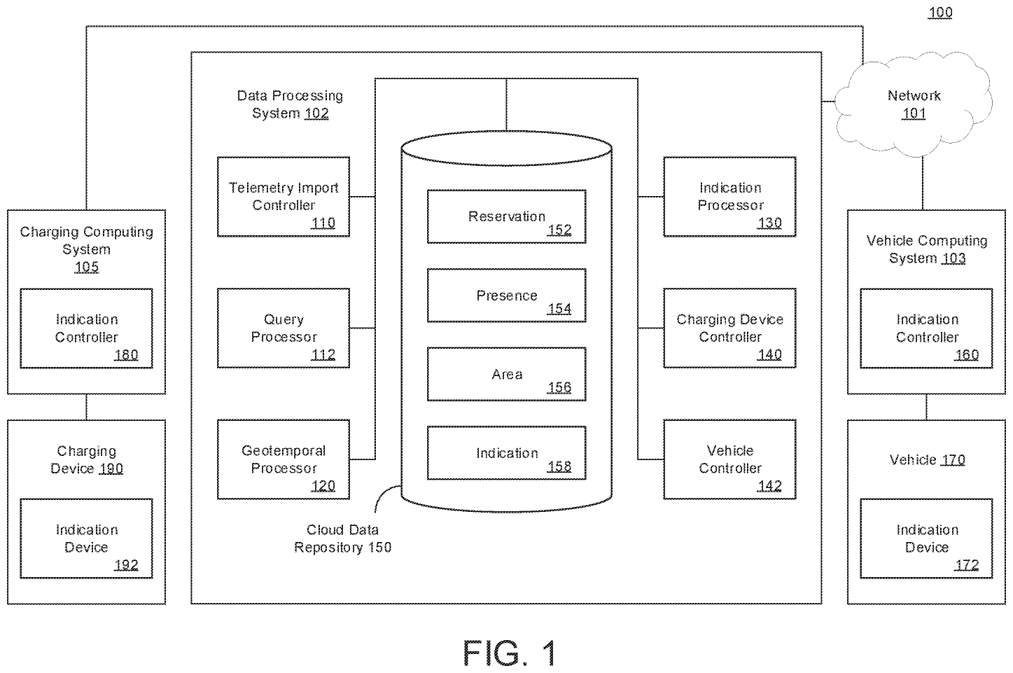

FIG. 1 depicts a system in accordance with present implementations. As illustrated by way of example in FIG. 1, a system 100 can include a network 101, a data processing system 102, a vehicle computing system 103, a charging computing system 105, a vehicle 170, and a charging device 190. The network 101 can be any type or form of network. The geographical scope of the network 101 can vary widely and the network 101 can be a body area network (BAN), a personal area network (PAN), a local-area network (LAN), e.g. Intranet, a metropolitan area network (MAN), a wide area network (WAN), or the Internet. The topology of the network 101 can be of any form and can include, e.g., any of the following: point-to-point, bus, star, ring, mesh, or tree. The network 101 can be an overlay network which is virtual and sits on top of one or more layers of other networks 101. The network 101 can be of any such network topology as known to those ordinarily skilled in the art capable of supporting the operations described herein. The network 101 can utilize different techniques and layers or stacks of protocols, including, e.g., the Ethernet protocol, the internet protocol suite (TCP/IP), the ATM (Asynchronous Transfer Mode) technique, the SONET (Synchronous Optical Networking) protocol, or the SDH (Synchronous Digital Hierarchy) protocol. The TCP/IP internet protocol suite can include application layer, transport layer, internet layer (including, e.g., IPv6), or the link layer. The network 101 can be a type of a broadcast network, a telecommunications network, a data communication network, or a computer network. The data processing system 102 can include a telemetry import controller 110, a query processor 112, a geotemporal processor 120, an indication processor 130, a charging device controller 140, a vehicle controller 142, and a cloud data repository 150.

The telemetry import controller 110 can obtain one or more parameters generated at one or more of the charging device and the vehicle 170. The telemetry import controller 110 can obtain parameters from the vehicle 170 via the network 101 and via an application programming interface (API) compatible with one or more components of the vehicles or the vehicle computing system 103. The telemetry import controller 110 can obtain, for example, a location generated at the vehicle 170 and a timestamp generated at the vehicle 170. The location and the timestamp can be linked to indicate a location of the vehicle at a particular time. The location can include a coordinate, address, latitude, longitude, or any combination thereof. The telemetry import controller 110 can obtain one or more parameters in connected with a query obtained at the data processing system 102 via the network 101. The data processing system 102 can obtain the query via the vehicle 170, or via an electronic device linked to the vehicle 170. The telemetry import controller 110 can obtain parameters embedded in or transmitted separately from a query. The telemetry import controller 110 can transmit the query to the query processor 120. The telemetry import controller 110 can continue to or continuously receive parameters from the vehicle 170 in response to receiving the query.

The query processor 112 can identify and process one or more parameters included in or with a query, or referenced by a query. The query processor 112 can extract one or more parameters from the received query and can transmit the extracted parameters to any component of the data processing system 102. For example, the query processor 112 can extract a location and a time from the query. The query processor 112 can identify the vehicle 170 transmitting the query, and can identify a reservation corresponding to the query or referenced by the query, for example. The query processor 112 can identify from the query a time of the reservation, and a location of the reservation. The time of the reservation can correspond to a timestamp and the location of the reservation can correspond to a location as discussed herein. The query processor 112 can transmit one or more of the parameters of the query, including those discussed herein, to the geotemporal processor 120.

The geotemporal processor 120 can generate one or more determinations based on location and time data. The geotemporal processor 120 can generate one or more determinations relative to a particular charging device and a particular vehicle. The particular charging device can include the charging device 190, and the particular vehicle can include the vehicle 170. The geotemporal processor 120 can generate a determination of whether or not the vehicle 170 has arrived at an area corresponding to a location of the charging device 190. For example, the geotemporal processor 120 can determine whether a location of the vehicle 170 is at or within a geofence corresponding to the boundaries of a parking lot containing the charging device 190. The geotemporal processor 120 can generate a relative distance between the vehicle 170 and the charging device 190. The geotemporal processor 120 can determine whether the vehicle 170 has arrived at an area including the charging device 190 within a predetermined time threshold. The time threshold can be a static threshold or a dynamic threshold. For example, a static threshold can be a fixed offset of 15 minutes, indicating a 15 minute “grace period” before a reservation of the charger expires in the absence of an arrival of the vehicle at the area including the charging device 190. For example, a dynamic threshold can include a variable offset of minutes based on percentage of reservation of vehicles. For example, the grace period can be extended to 30 minutes if over half of the charger devices at the area are not reserved. The geotemporal processor 120 can provide one or more determination to the indication processor 130.

The data processing system can identify, based on the charge query, a first time corresponding to an estimated time of arrival of the vehicle at the area, and a reservation by the vehicle of the charging device at the first time. The data processing system can obtain, based on the presence of the vehicle in the area, a second time corresponding to an actual time of arrival of the vehicle at the area. The data processing system can instruct, in response to a first determination that the second time satisfies a threshold based on the first time, the component of the charging device to output the first presentation indicative of the reservation.

The indication processor 130 can generate one or more instructions to activate one or more indication devices of one or more of the vehicle 170 and the charging device 190. The indication processor 130 can activate indication devices of the charging device 190 or the vehicle 170 in response to various telemetry conditions corresponding to various determinations by the geotemporal processor 120. The indication processor 130 can instruct the charging device 190 to present a reservation presentation in response to a determination by the geotemporal processor 120 that a query for the vehicle 170 is within a maximum reservation time threshold in the future, and that the vehicle 170 is outside of the area including the charging device 190. The indication processor 130 can instruct the charging device 190 and the vehicle 170 to each present coordinated presentations in response to a determination by the geotemporal processor 120 that an arrival of the vehicle 170 in the area including the charging device 190 is within a grace period time threshold, and that the vehicle 170 is inside of the area including the charging device 190. The indication processor 130 can select an unreserved charging device 190 in the area and assign to or link with the vehicle 170 the selected charging device 190.

The indication processor 130 can instruct the charging device 190 and the vehicle 170 to each modify their respective coordinated presentations in response to a determination by the geotemporal processor 120 that the vehicle 170 in the area including the charging device 190 is moving relative to the charging device 190, and that the vehicle 170 is inside of the area including the charging device 190. The indication processor 130 can continuously update and monitor determinations from the geotemporal processor 120 and correspondingly continuously update instructions to the vehicle 170 or the charging device 190. The indication processor 130 can transmit instructions for the charging device 190 to the charging device controller 140 and instructions for the vehicle 170 to the vehicle controller 142. The first presentation can include a first light color and the second presentation can include a second light color distinct from the first light color.

The charging device controller 140 can transmit one or more instructions to the charging computing system 105 to modify operation of the charging device 190, an indication device thereof, or any component thereof. The charging device controller 140 can obtain an instruction from the indication processor 130 to modify operation of one or more indication devices of the charging device 190. The charging device controller 140 can modify or transform an instruction received from the indication processor 130 to be compatible with transmission to the charging computing system 105 via the network 101, for example. The charging device controller 140 can modify or transform an instruction received from the indication processor 130 to be compatible an API corresponding specifically to the charging computing system 105.

The data processing system can instruct, in response to the presence of the vehicle in the area, a light emitting device integrated with the charging device to output the first presentation including at least one of a light color and a light pattern. The data processing system can instruct, based on the presence of the vehicle in the area, the light emitting device integrated with the charging device to modify the light pattern. The data processing system can instruct, in response to a second determination that the first time satisfies a second threshold based on a predetermined time period, the component of the charging device to output a third presentation indicative of a reservation by the vehicle of the charging device at the first time.

The vehicle controller 142 can transmit one or more instructions to the vehicle computing system 103 to modify operation of the vehicle 170, an indication device thereof, or any component thereof. The vehicle controller 142 can obtain an instruction from the indication processor 130 to modify operation of one or more indication devices of the vehicle 170. The vehicle controller 142 can modify or transform an instruction received from the indication processor 130 to be compatible with transmission to the vehicle computing system 103 via the network 101, for example. The vehicle controller 142 can modify or transform an instruction received from the indication processor 130 to be compatible an API corresponding specifically to the vehicle computing system 103.

The data processing system can instruct, in response to the presence of the vehicle in the area, a light emitting device integrated with the vehicle to output the second presentation including at least one of the light color and the light pattern. The data processing system can instruct, based on the presence of the vehicle in the area, the light emitting device integrated with the vehicle to modify the light pattern. The data processing system can instruct, in response to the presence of the vehicle in the area, a user interface integrated with the charging device to output the first presentation including at least one of video or audio. The data processing system can instruct, in response to the presence of the vehicle in the area, the user interface integrated with the vehicle to output the second presentation including at least one of video or audio personalized to an operator of the vehicle.

The cloud data repository 150 can store one or more types and collections of data associated with the vehicle 170. The cloud data repository 150 can include reservation storage 152, presence storage 152, area storage 156 and indication storage 158.

The reservation storage 152 can store parameters associated with or extracted from various reservations or queries obtained by the telemetry import controller 110. The indication processor 130 can read the reservation storage 152 to determine a charging device that is unreserved. The presence storage 154 can store status of one or more vehicles 170 with respect to one or more areas including charging devices. The presence storage 154 can store binary data comprising indications of whether a particular vehicle is in a particular area. The presence storage 154 can store nonbinary state indicators indicating a relative or absolute distance between particular vehicles and particular charging devices. The presence storage 154 can link any presence indication with any query, reservation, vehicle, charging device, or any combination thereof. The area storage 156 can store location data and charging device data associated with one or more areas including one or more charging devices. The area storage 156 can store geofences defining one or more particular areas, and can define one or more charging devices respectively associated with particular areas. The indication storage 158 can store indication characteristics corresponding to one or more types of indications. For example, the indication storage 158 can store data defining one or more colors or color patterns, one or more user interface objects, images, video segments, test strings, audio, or any combination thereof. For example, the indication storage 158 can identify various combinations of data to define various coordinated indications between a vehicle and a charging device.

The vehicle computing system 103 can communicate with the data processing system 102 by the network 101, and can communicate with the vehicle 170 by one or more communication protocols therebetween. The vehicle computing system 103 can include an indication controller 160. The vehicle computing system 103 can be integrated with the vehicle 170, and can communicate bidirectionally with one or more components integrated with the vehicle 170 or operatively coupled with the vehicle 170. The indication controller 160 can instruct one or more illumination devices, user interface devices, displays, audio devices, or any combination thereof, linked to or integrated with the vehicle 170 to activate, deactivate, or modify operation thereof. The indication controller 160 can communicate with indication device 172 by a component communication channel integrated with the vehicle 170.

The vehicle 170 can include an electric vehicle. The vehicle 170 can include an indication device 172. The indication device 172 can include one or more illumination devices, user interface devices, displays, audio devices, or any combination thereof, linked to or integrated with the vehicle 170. The indication device 172 can include any device that can generate output perceptible to at least one human sense, including at least sight and sound.

The charging computing system 105 can communicate with the data processing system 102 by the network 101, and can communicate with the charging device 190 by one or more communication protocols therebetween. The charging computing system 105 can include an indication controller 180. The indication controller 180 can instruct one or more illumination devices, user interface devices, displays, audio devices, or any combination thereof, linked to or integrated with the charging device 190 to activate, deactivate, or modify operation thereof. The indication controller 180 can communicate with indication device 192 by a component communication channel integrated with the charging device 190.

The charging device 190 can operatively couple with the vehicle to provide, for example, electric charge to battery of the vehicle 170. The charging device 190 can include an indication device 192. The indication device 192 can include one or more illumination devices, user interface devices, displays, audio devices, or any combination thereof, linked to or integrated with the charging device 190. The indication device 192 can include any device that can generate output perceptible to at least one human sense, including at least sight and sound.

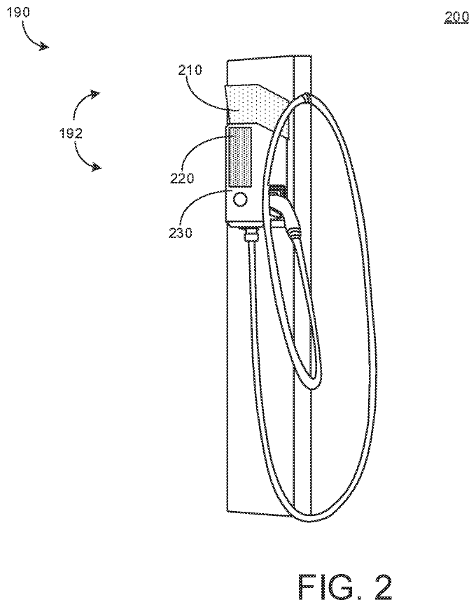

FIG. 2 depicts a view of a charging device, in accordance with present implementations. As illustrated by way of example in FIG. 2, a view 200 can include the charging device 190 and a plurality of indication devices 192. The indication devices 192 can include an illumination device 210, a user interface display device 220 and an audio device 230.

The illumination device 210 can include one or more light-emitting devices and a housing at least partially enclosing the light light-emitting elements. The light-emitting elements can include, for example, light-emitting diode (LED) lights or incandescent lights. The light-emitting elements can generate light having one or more colors, and can generate one or more colors concurrently or in sequence. The light-emitting elements can be activated based on particular directions with respect to the charging device 190. For example, the light-emitting elements can be activated based on an orientation to illuminate a front, rear, left side, right side, top, bottom, or any combination thereof, of the charging device 190. The housing can include a transparent or translucent material in the shape of an enclosure at least partially surrounding the light-emitting elements.

The user interface display device 220 can include a display operate to present a user interface. The user interface display device 220 can include an electronic display. An electronic display can include, for example, a liquid crystal display (LCD), a light-emitting diode (LED) display, an organic light-emitting diode (OLED) display, or the like. The display device can be housed at least partially within the charging device 190.

The audio device 230 can generate output audible at least within frequencies and volumes corresponding to the human sense of hearing. The audio device 230 can include one or more speakers integrated with or embedded within the charging device 190. The audio device 230 can generate voice, beeps, rings, tones, music, or any combination thereof, for example.

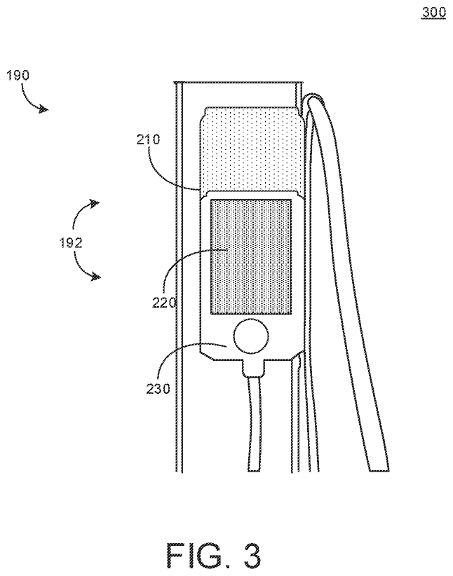

FIG. 3 depicts a view of a charging device, in accordance with present implementations. As illustrated by way of example in FIG. 3, a second view of a charging device 300 can include the illumination device 210, the user interface display device 220, and the audio device 230.

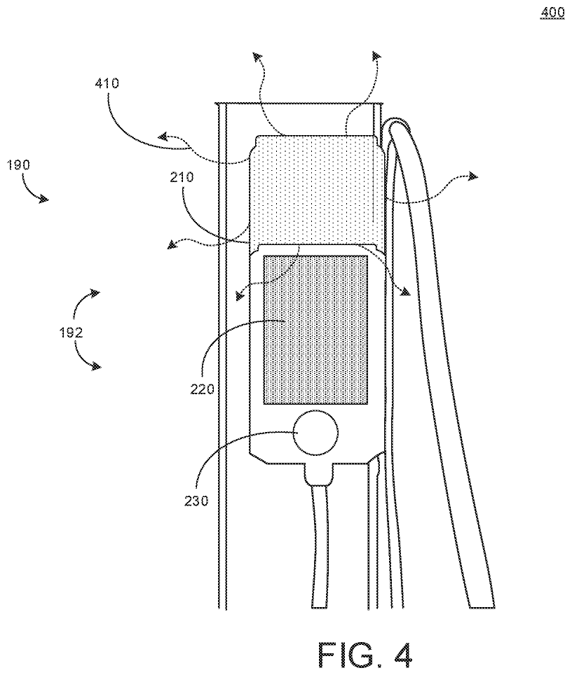

FIG. 4 depicts a charging device having an activated illumination device, in accordance with present implementations. As illustrated by way of example in FIG. 4, a state 400 can include the illumination device 210 in an activated state, the user interface display device 220, the audio device 230, and a light color or light pattern 420. The illumination device 210 in an activated state can output one or more light colors or patterns from the light-emitting devices thereof. For example, the illumination device 210 in an activated state can output one or more colors including but not limited to red, orange, yellow, green, blue, indigo, violet, teal, cyan, magenta, or any combination thereof. For example, the illumination device 210 in an activated state can output one or more patterns including flashing, pulsating, blinking, marquee, or any combination thereof. For example, the illumination device 210 in an activated state can cycles through one or more colors, patterns, or any combination thereof. The light color or light pattern 420 can be emitted by the illumination device 210 in an activated state. The light color or light pattern 420 can include any subset or combination of the light colors or patterns that the illumination device 210 can generate or be instructed to generate.

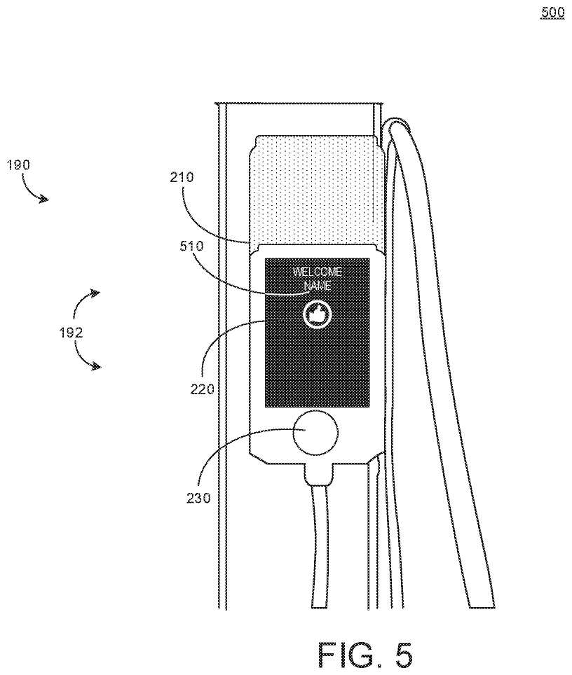

FIG. 5 depicts a charging device having an activated display device, in accordance with present implementations. As illustrated by way of example in FIG. 5, a state 500 can include the illumination device 210, the user interface display device 220 in an activated state, the audio device 230, and individualized user interface elements 510. The user interface display device 220 in an activated state can present a user interface by the user interface display device 220. The charging device can by a user interface output, in response to the presence of the vehicle in the area, the first presentation including at least one of video or audio. The individualized user interface elements 520 can include any images, video segments, test strings, audio, or any combination thereof. For example, the user interface display device 220 in an activated state can present text including text personalized to a particular user of a particular vehicle, or a particular vehicle. For example, the user interface display device 220 in an activated state can present images or video to indicate arrival or navigation progress. For example, the user interface can present a “thumbs up” image or glyph indicating that the vehicle linked to the charging device has arrived and the charging device is activated for use by the particular vehicle.

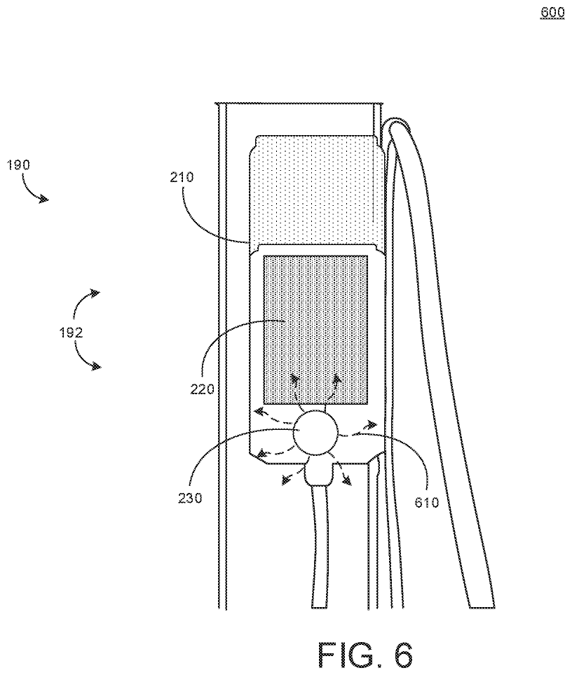

FIG. 6 depicts a charging device having an activated audio device, in accordance with present implementations. As illustrated by way of example in FIG. 6, a charging device having an activated audio device 600 can include the illumination device 210, the user interface display device 220, the audio device 230 in an activated state, and a sound output 610. The audio device 230 in an activated state can output one or more sounds audible at least within frequencies and volumes corresponding to the human sense of hearing. The sound output 610 can include voice, beeps, rings, tones, music, or any combination thereof, for example.

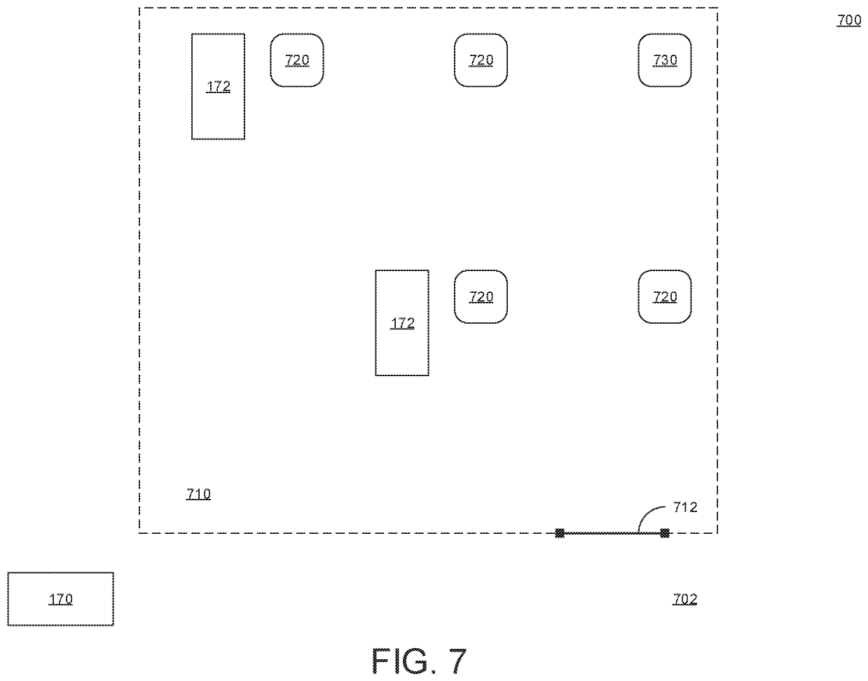

FIG. 7 depicts a charging area, in accordance with present implementations. As illustrated by way of example in FIG. 7, a physical space 700 can include a physical space outside charging area 702, a charging area 710, an entrance 712 to the charging area 710, charging devices 720, a charging device 730 linked to the vehicle 170, and vehicles 172 in the charging area 710. The physical space outside charging area 702 can include any geography, region, jurisdiction, or any combination thereof excluded from the charging area. For example, the physical space outside charging area 702 can include a metropolitan area within which the vehicle 170 is operated.

The charging area 710 can include any physical location or collection of physical location within boundaries defined by the area storage 156. For example, the charging area 710 can include a parking lot or parking structure including one or more charging devices, and can correspond to a geofence surrounding a footprint of the parking lot or the parking structure. A geofence corresponding to the charging area 710 can include a plurality of coordinates defining a polygonal or ovoid shape encompassing the charging area 710. A geofence corresponding to the charging area 710 can include a single coordinate defining a circular shape encompassing the charging area 710. A coordinate can include one or points defined as latitude and longitude, or any coordinate system.

The entrance to charging area 712 can include a physical structure permitting or directing one or more of entry to and exit from the charging area 710. The physical structure can include a curb or gate configured to allow entry of the vehicle 170, or signage indicating entry, exit, or both. The area storage 156 can define the entrance 712 with one or more coordinates or with respect to one or more coordinates, edges, or arcs of a geofence defining the charging area 710, for example. The geotemporal processor 120 can determine that the vehicle 170 has crossed the entrance 712 where the area storage 156 defines the entrance 156. The indication processor 130 can instruct one or more of the indication devices 172 and 192 to activate, deactivate, or modify operation to any state discussed herein based on the determination that the vehicle 170 has crossed the entrance 712.

The charging devices 720 can correspond in one or more of structure and operation to the charging device 190. The charging devices 720 can be assigned to or linked with various ones of vehicles 172 by the data processing system 102, or not assigned to or linked with any vehicle. The vehicles 172 in the charging area 710 can be distinct from the vehicle 170 and operate independently from the vehicle 170. The charging device 730 linked to the vehicle 170 can be linked to the vehicle 170 in response to a query corresponding to a request to reserve a charging device in the charging area 710. The query can be generated by the vehicle 170 or can be generated by a device distinct from the vehicle 170 and referencing the vehicle 170.

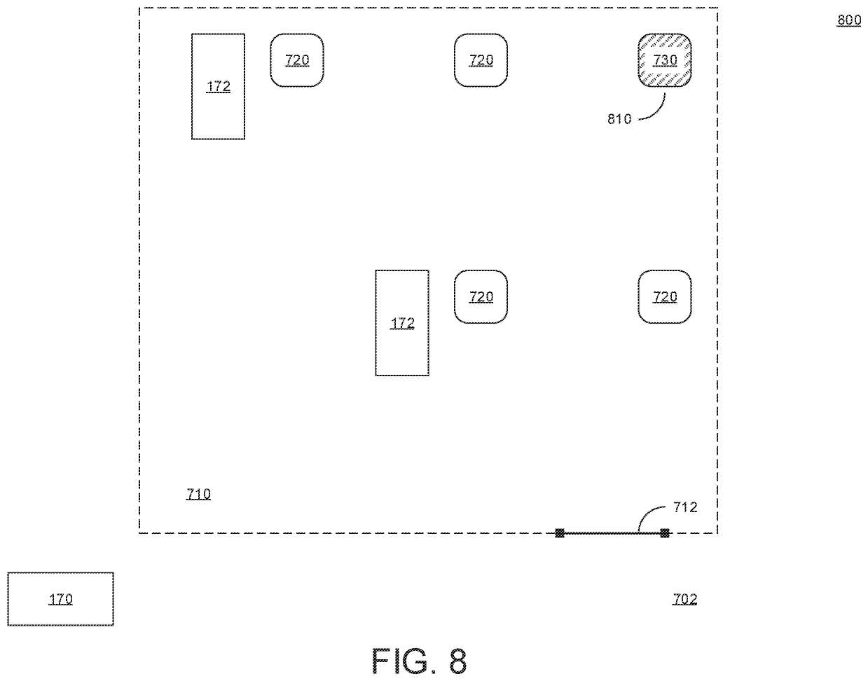

FIG. 8 depicts a charging area, in accordance with present implementations. As illustrated by way of example in FIG. 8, a physical space 800 can include the physical space 702 outside the charging area 710, the charging area 710, the entrance 712 to the charging area 710, the charging devices 720, the charging device 730 linked to the vehicle 170, the vehicles 172 in the charging area 710, and a reservation indication 810. The reservation indication 810 can indicate that the charging device 730 is reserved at a particular time or during a particular time range for operation by a particular vehicle. The reservation indication 810 can be generated by the illumination device 210.

The vehicle can by the processors transmit a parameter indicative of a reservation by the vehicle of the charging device at the first time and including an identifier of the vehicle, the area, and a first time corresponding to an estimated time of arrival of the vehicle at the area. The vehicle can transmit, based on the area and a location corresponding to the vehicle, a second time corresponding to an actual time of arrival of the vehicle at the area. The vehicle can output, by the light emitting device in response to a determination that the second time satisfies a threshold based on the first time, the first presentation. The charging device can by the light emitting device output, in response to a second determination that a first time satisfies a second threshold based on a predetermined time period, a third presentation indicative of a reservation by the vehicle of the charging device at the first time. For example, the reservation indication 810 can include a red color having a solid pattern indicating that the charging device 730 is reserved for the exclusive use of a vehicle that is outside the charging area 710 or in the physical space 702, at a time before the vehicle 170 has arrived at or within the charging area 710.

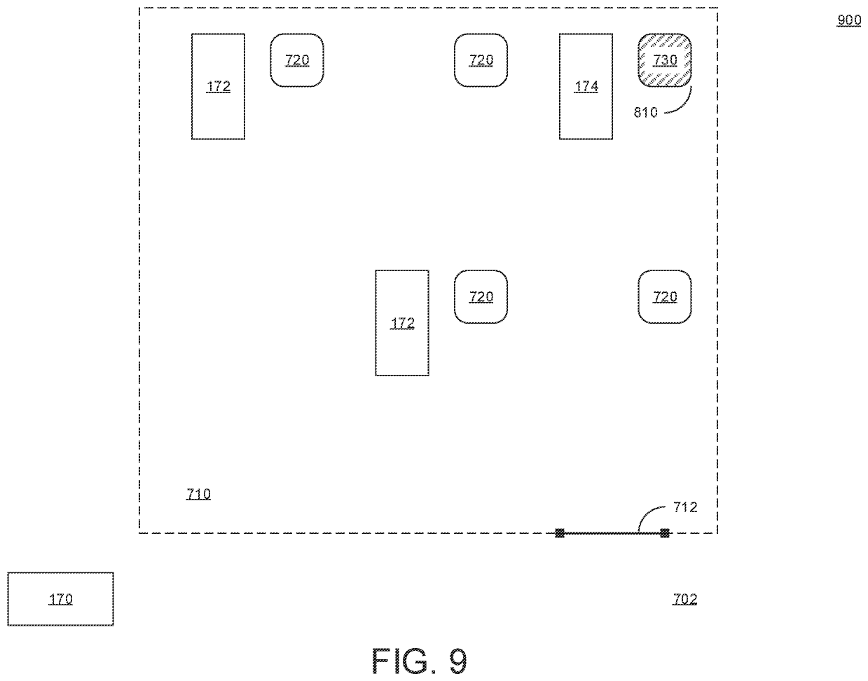

FIG. 9 depicts a charging area, in accordance with present implementations. As illustrated by way of example in FIG. 9, a physical space 900 can include the physical space outside charging area 702, the charging area 710, the entrance to charging area 712, the charging devices 720, the charging device linked to the vehicle 170 730, the vehicles 172 in the charging area 710 172, a vehicle 174, and the reservation indication 810.

The vehicle 174 can be located at the charging device 130. The vehicle 172 can be blocked from use of the charging device 730 because the vehicle 174 is not the vehicle 170, and thus is not authorized to access the charging device 730 while the charging device 730 is reserved by the vehicle 170. The reservation indication 810 can remain constant or can be modified to indicate that the vehicle 174 is not authorized to use the charging device 730. For example, the reservation indication 810 can include the illumination device continuing to present a red color, and may be modified to add a flashing or pulsating light pattern in the red color. For example, the user interface display device 220 can present text explaining that vehicle 174 is not authorized to use the charging device 730 while the reservation that links the charging device 730 to the vehicle 170 is active. For example, the user interface display device 220 can present text or numbers indicating a time after the grade period when the reservation will expire and the charging device 730 will be open for the vehicle 174 to use.

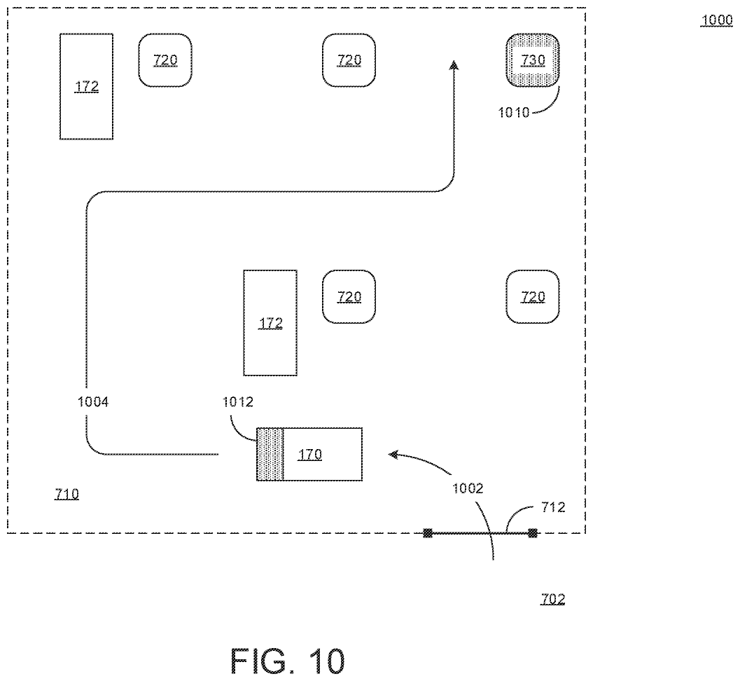

FIG. 10 depicts a charging area, in accordance with present implementations. As illustrated by way of example in FIG. 10, a physical space 1000 can include the physical space outside charging area 702, the charging area 710, the entrance to charging area 712, the charging devices 720, the charging device linked to the vehicle 170 730, the vehicles 172 in the charging area 710 172, an entry path 1002 of the vehicle 170 into the charging area 710, a navigation path 1004 in the charging area 710 to the charging device 730, a destination indication 1010, and a navigation indication 1012. The entry path 1002 of the vehicle 170 into the charging area 710 can correspond to a travel path of the vehicle 170 from the physical space 102 to the charging area 710 via the entrance 712.

The navigation path 1004 in the charging area 710 to the charging device 730 can correspond to a route for the vehicle 170 from the entrance 712 to the charging device 730. The geotemporal processor 120 can receive location data from the vehicle 170 as it moves along the navigation path 1004. The geotemporal processor 120 can provide location data to the indication processor 130. The indication processor 130 can instruct an indication device of the vehicle 170 to present an indication corresponding to an indication for the charging device 190, upon arrival of the vehicle 170 in the charging area 710 or upon crossing the entrance 712, for example.

The destination indication 1010 can correspond to a particular light color or light pattern, and can match or correspond to the navigation indication 1012. The charging device 730 can present the destination indication 1010 by the illumination device 210 or the display 220, for example. The charging device can by the processors generate, based on an identification of the vehicle, the area, a first time corresponding to an estimated time of arrival of the vehicle at the area, and a second time corresponding to an actual time of arrival of the vehicle at the area based on the area and a location corresponding to the vehicle, an instruction to output the first presentation. The charging device can output, by the light-emitting device in response to a first determination that the second time satisfies a threshold based on the first time, the first presentation. The charging device can by the light emitting device output, in response to the presence of the vehicle in the area, the first presentation including at least one of a light color or a light pattern, the second presentation including at least one of the light color or the light pattern. The destination indication 1010 can have a particular color. For example, the color can be violet.

The navigation indication 1012 can correspond to a particular light color or light pattern, and can match or correspond to the destination indication 1010. A light device of the vehicle 170 can present the navigation indication 1012. Light devices of a vehicle can include dash lights, floor lights, cabin lights, headlights, fog lights, taillights, backup lights, tails lights, or any other light linked with or integrated with the vehicle 170. For example, the navigation indication 1012 can be a violet light emitted by the floor lights of the vehicle, matching a violet light emitted by the charging device 730. A user interface of the vehicle can present a navigation indication 1012. For example, a touchscreen of the vehicle 170 can present a violet color band or violet color block matching a violet light emitted by the charging device 730.

The vehicle can output, by the light emitting device in response to presence of the vehicle in the area, a first presentation indicative of the request and corresponding to a second presentation output by a component of the charging device. The vehicle can by the light emitting device output, in response to the presence of the vehicle in the area, the first presentation including at least one of a first light color or a first light pattern that matches at least one of a second light color or a second light pattern can include the second presentation. The vehicle can include a user interface to output, in response to the presence of the vehicle in the area, the first presentation including at least one of video or audio personalized to an operator of the vehicle.

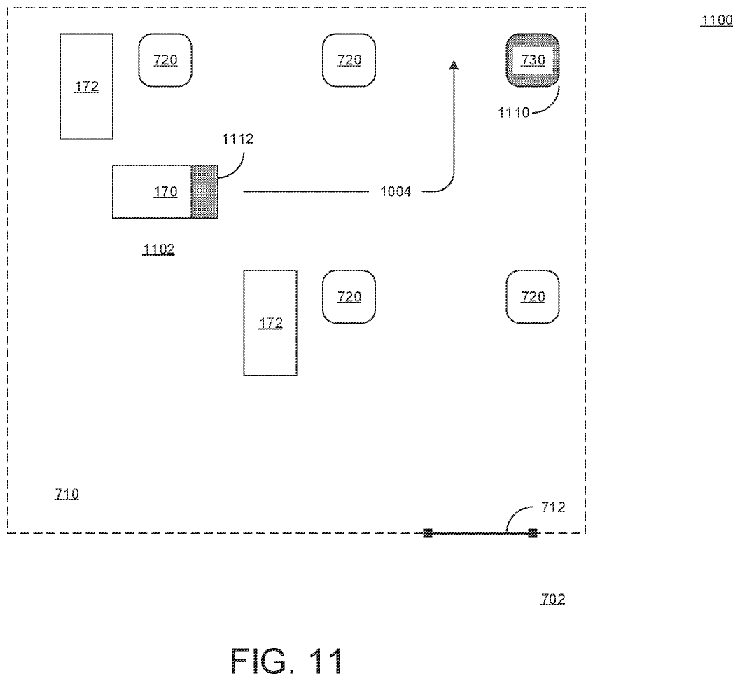

FIG. 11 depicts a charging area, in accordance with present implementations. As illustrated by way of example in FIG. 11, a physical space 1100 can include the physical space 702 outside charging area 710, the charging area 710, the entrance to charging area 712, the charging devices 720, the charging device 7301 inked to the vehicle 170, the vehicles 172 in the charging area 710, the navigation path 1004, an intermediate location 1102, a proximity indication 1110, and an approach indication 1112. The intermediate location 1102 can correspond to a location in the charging area 710 along the navigation path 1004. The intermediate location 1102 can be a location between the entrance 712 and the charging device 730 along the navigation path 1004.

The proximity indication 1110 can correspond to a particular light color or light pattern, and can match or correspond to the approach indication 1112. The charging device 730 can present the proximity indication 1110 by the illumination device 210 or the display 220, for example. The proximity indication 1110 can differ from the destination indication 1010 with respect to one or more characteristics. For example, the proximity indication 1110 can have a violet color matching the destination indication 1010, and have a flashing pattern or pulsating pattern corresponding to varying brightness. The charging device can by the light emitting device modify, based on the presence of the vehicle in the area and the location, the light pattern. For example, a frequency of flashing or pulsating of the proximity indication 1110 can increase as the vehicle 170 approaches the charging device 730. For example, a brightness of the proximity indication 1110 can increase as the vehicle 170 approaches the charging device 730.

The approach indication 1112 can correspond to a particular light color or light pattern, and can match or correspond to the proximity indication 1110. The vehicle 170 can present the approach indication 1112 by the cabin lights or floor lights, for example. The approach indication 1112 can differ from the navigation indication 1012 with respect to one or more characteristics. For example, the approach indication 1112 can have a violet color matching the navigation indication 1012, and have a flashing pattern or pulsating pattern corresponding to varying brightness. The vehicle can include the second light pattern modified to match the first light pattern. The vehicle by the light emitting device can modify, based on the presence of the vehicle in the area, the first light pattern. For example, a frequency of flashing or pulsating of the approach indication 1112 can increase as the vehicle 170 approaches the charging device 730. For example, a brightness of the approach indication 1112 can increase as the vehicle 170 approaches the charging device 730. For example, a user interface of a touchscreen or display of the vehicle 170 can present text or glyphs corresponding to a statement of approach toward the charging device 730.

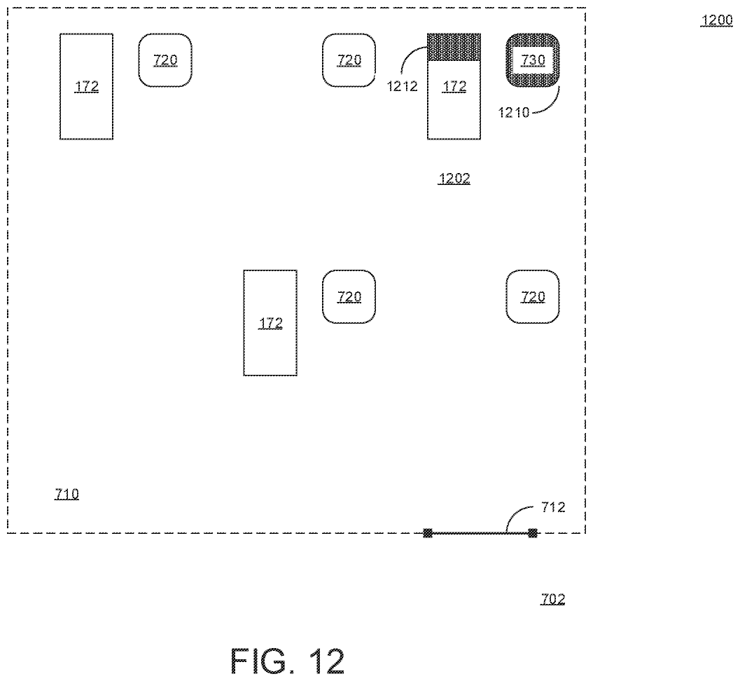

FIG. 12 depicts a charging area, in accordance with present implementations. As illustrated by way of example in FIG. 12, a physical space 1200 can include the physical space outside charging area 702, the charging area 710, the entrance 712 to the charging area 710, the charging devices 720, the charging device 730 linked to the vehicle 170, the vehicles 172 in the charging area 710, a destination location 1202, an activation indication 1210, and an arrival indication 1212. The destination location 1202 can correspond to an end location in the charging area 710 along the navigation path 1004. The destination location 1202 can be a location beyond the entrance 712 and at charging device 730 along the navigation path 1004.

The activation indication 1210 can correspond to a particular light color or light pattern. The charging device 730 can present the activation indication 1210 by the illumination device 210 or the display 220, for example. The activation indication 1210 can differ from the destination indication 1010 with respect to one or more characteristics. For example, the activation indication 1210 can have a blue color distinct from the proximity indication 1110, and have a flashing pattern or pulsating pattern corresponding to varying brightness. For example, a frequency of flashing or pulsating of the activation indication 1210 can be constant after the vehicle 170 arrives at the charging device 730. For example, a brightness of the activation indication 1210 can be constant after the vehicle 170 arrives at the charging device 730.

The arrival indication 1212 can correspond to a particular light color or light pattern. The vehicle 170 can present the arrival indication 1212 by the cabin lights or floor lights, for example. The arrival indication 1212 can differ from the approach indication 1112 with respect to one or more characteristics. For example, the arrival indication 1212 can have a blue color matching the activation indication 1210, and have a flashing pattern or pulsating pattern corresponding to varying brightness. For example, a frequency of flashing or pulsating of the arrival indication 1212 can be constant after the vehicle 170 arrives at the charging device 730. For example, a brightness of the arrival indication 1212 can be constant after the vehicle 170 arrives at the charging device 730. For example, a user interface of a touchscreen or display of the vehicle 170 can present text or glyphs corresponding to a statement of arrival at and authorization to use the charging device 730.

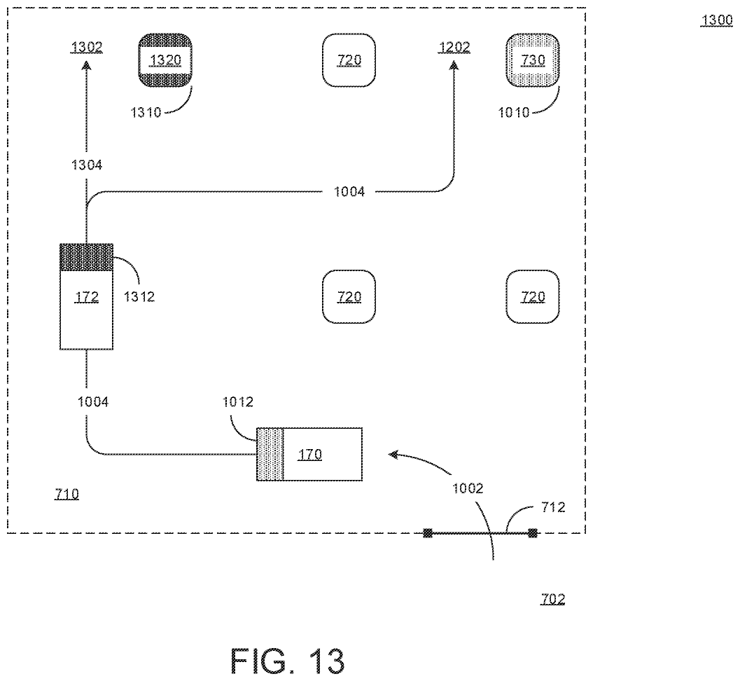

FIG. 13 depicts a charging area, in accordance with present implementations. As illustrated by way of example in FIG. 13, a physical space 1300 can include the physical space 702 outside the charging area 710, the charging area 710, the entrance 712 to the charging area 710, the charging devices 720, the charging device 730 linked to the vehicle 170, a vehicle 172 in the charging area 710, the navigation path 1004, the destination indication 1010, the navigation indication 1012, the destination location 1202, a second destination location 1302, a second navigation path 1304, a second destination indication 1310, a second navigation indication 1312, and a charging device 1320 linked to the vehicle 172.

The second destination location 1302 can correspond to an end location in the charging area 710 along the second navigation path 1304. The destination location 1202 can be a location beyond the entrance 712 and at charging device 1320 along the navigation path 1304. The second navigation path 1304 in the charging area 710 to the charging device 1320 can correspond to a route for the vehicle 172 from the entrance 712 to the charging device 1320. The geotemporal processor 120 can receive location data from the vehicle 172 as it moves along the second navigation path 1304. The geotemporal processor 120 can provide location data to the indication processor 130. The indication processor 130 can instruct an indication device of the vehicle 172 to present an indication corresponding to an indication for the charging device 1320, upon arrival of the vehicle 170 in the charging area 710 or upon crossing the entrance 712, for example.

The second destination indication 1310 can correspond to a particular light color or light pattern, and can match or correspond to the second navigation indication 1312 and be distinct from or different from the navigation indication 1012. The charging device 1320 can present the second destination indication 1310 by the illumination device 210 or the display 220, for example. The second destination indication 1310 can have a particular color distinct from or different from the destination indication 1010. For example, the color of the second destination indication 1310 can be orange to advantageously distinguish the charging device 730 from the charging device 1302 having a violet destination indication 1010 to navigate the vehicles 170 and 172 to their correspondingly reserved charging devices.

The second navigation indication 1312 can correspond to a particular light color or light pattern, and can match or correspond to the second destination indication 1310. A light device of the vehicle 172 can present the second navigation indication 1312. For example, the second navigation indication 1312 can be an orange light emitted by the floor lights of the vehicle, matching an orange light emitted by the charging device 1320. A user interface of the vehicle 172 can present a second navigation indication 1312. For example, a touchscreen of the vehicle 172 can present an orange color band or orange color block matching an orange light emitted by the charging device 1320. The charging device 1320 linked to the vehicle 172 can be linked to the vehicle 172 in response to a query corresponding to a request to reserve a charging device in the charging area 710. The query can be generated by the vehicle 172 or can be generated by a device distinct from the vehicle 172 and referencing the vehicle 172.

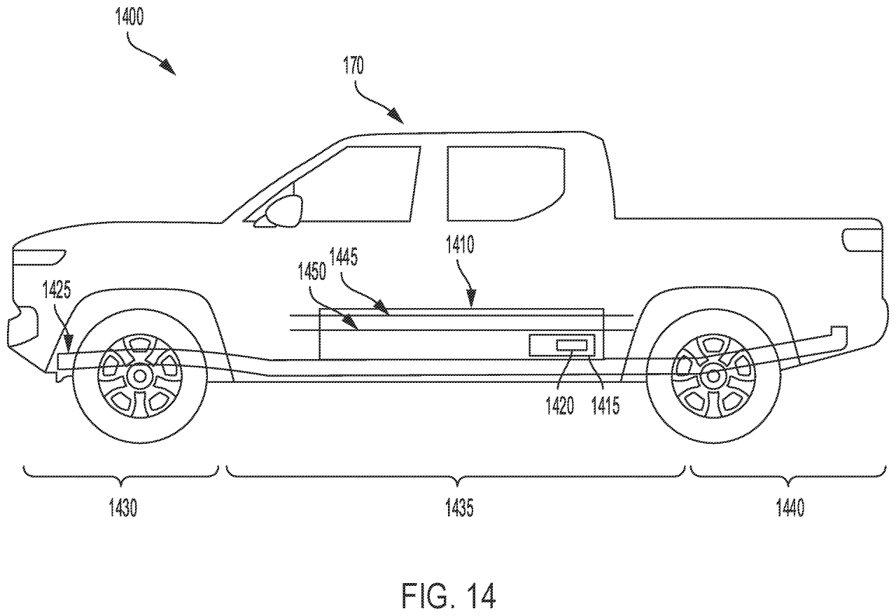

FIG. 14 depicts is an example cross-sectional view 1400 of an electric vehicle 170 installed with at least one battery pack 1410. Electric vehicles 170 can include electric trucks, electric sport utility vehicles (SUVs), electric delivery vans, electric automobiles, electric cars, electric motorcycles, electric scooters, electric passenger vehicles, electric passenger or commercial trucks, hybrid vehicles, or other vehicles such as sea or air transport vehicles, planes, helicopters, submarines, boats, or drones, among other possibilities. The battery pack 1410 can also be used as an energy storage system to power a building, such as a residential home or commercial building. Electric vehicles 170 can be fully electric or partially electric (e.g., plug-in hybrid) and further, electric vehicles 170 can be fully autonomous, partially autonomous, or unmanned. Electric vehicles 170 can also be human operated or non-autonomous. Electric vehicles 170 such as electric trucks or automobiles can include on-board battery packs 1410, battery modules 1415, or battery cells 120 to power the electric vehicles. The electric vehicle 170 can include a chassis 1425 (e.g., a frame, internal frame, or support structure). The chassis 1425 can support various components of the electric vehicle 170. The chassis 1425 can span a front portion 1430 (e.g., a hood or bonnet portion), a body portion 1435, and a rear portion 1440 (e.g., a trunk, payload, or boot portion) of the electric vehicle 170. The battery pack 1410 can be installed or placed within the electric vehicle 170. For example, the battery pack 1410 can be installed on the chassis 1425 of the electric vehicle 170 within one or more of the front portion 1430, the body portion 1435, or the rear portion 1440. The battery pack 1410 can include or connect with at least one busbar, e.g., a current collector element. For example, the first busbar 1445 and the second busbar 1450 can include electrically conductive material to connect or otherwise electrically couple the battery modules 1415 or the battery cells 1420 with other electrical components of the electric vehicle 170 to provide electrical power to various systems or components of the electric vehicle 170.

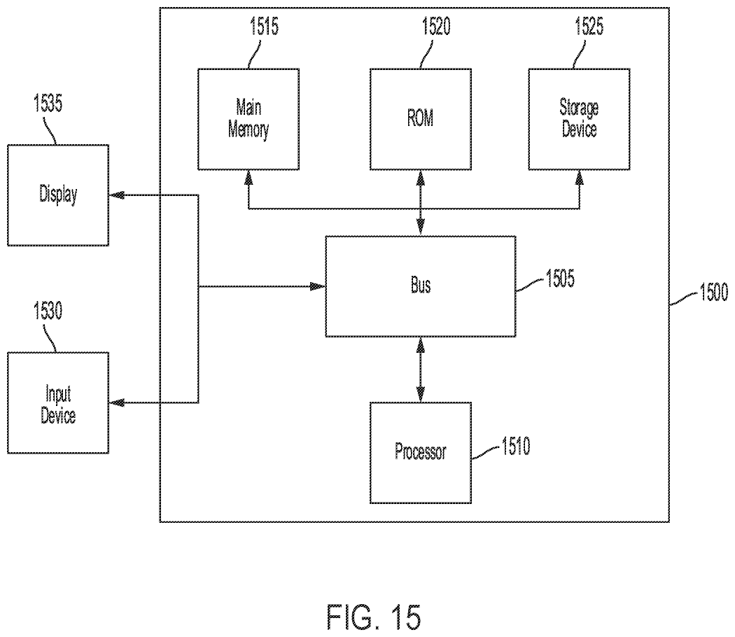

FIG. 15 depicts an example block diagram of an example computer system 1500. The computer system or computing device 1500 can include or be used to implement a data processing system or its components. The computing system 1500 includes at least one bus 1505 or other communication component for communicating information and at least one processor 1510 or processing circuit coupled to the bus 1505 for processing information. The computing system 1500 can also include one or more processors 1510 or processing circuits coupled to the bus for processing information. The computing system 300 also includes at least one main memory 1515, such as a random access memory (RAM) or other dynamic storage device, coupled to the bus 305 for storing information, and instructions to be executed by the processor 1510. The main memory 1515 can be used for storing information during execution of instructions by the processor 1510. The computing system 1500 may further include at least one read only memory (ROM) 1520 or other static storage device coupled to the bus 1505 for storing static information and instructions for the processor 1510. A storage device 1525, such as a solid state device, magnetic disk or optical disk, can be coupled to the bus 1505 to persistently store information and instructions.

The computing system 1500 may be coupled via the bus 1505 to a display 1535, such as a liquid crystal display, or active matrix display, for displaying information to a user such as a driver of the electric vehicle 1505 or other end user. An input device 1530, such as a keyboard or voice interface may be coupled to the bus 1505 for communicating information and commands to the processor 1510. The input device 1530 can include a touch screen display 1535. The input device 1530 can also include a cursor control, such as a mouse, a trackball, or cursor direction keys, for communicating direction information and command selections to the processor 1510 and for controlling cursor movement on the display 1535.

The processes, systems and methods described herein can be implemented by the computing system 1500 in response to the processor 1510 executing an arrangement of instructions contained in main memory 1515. Such instructions can be read into main memory 1515 from another computer-readable medium, such as the storage device 1525. Execution of the arrangement of instructions contained in main memory 1515 causes the computing system 1500 to perform the illustrative processes described herein. One or more processors in a multi-processing arrangement may also be employed to execute the instructions contained in main memory 1515. Hard-wired circuitry can be used in place of or in combination with software instructions together with the systems and methods described herein. Systems and methods described herein are not limited to any specific combination of hardware circuitry and software.

Although an example computing system has been described in FIG. 15, the subject matter including the operations described in this specification can be implemented in other types of digital electronic circuitry, or in computer software, firmware, or hardware, including the structures disclosed in this specification and their structural equivalents, or in combinations of one or more of them.

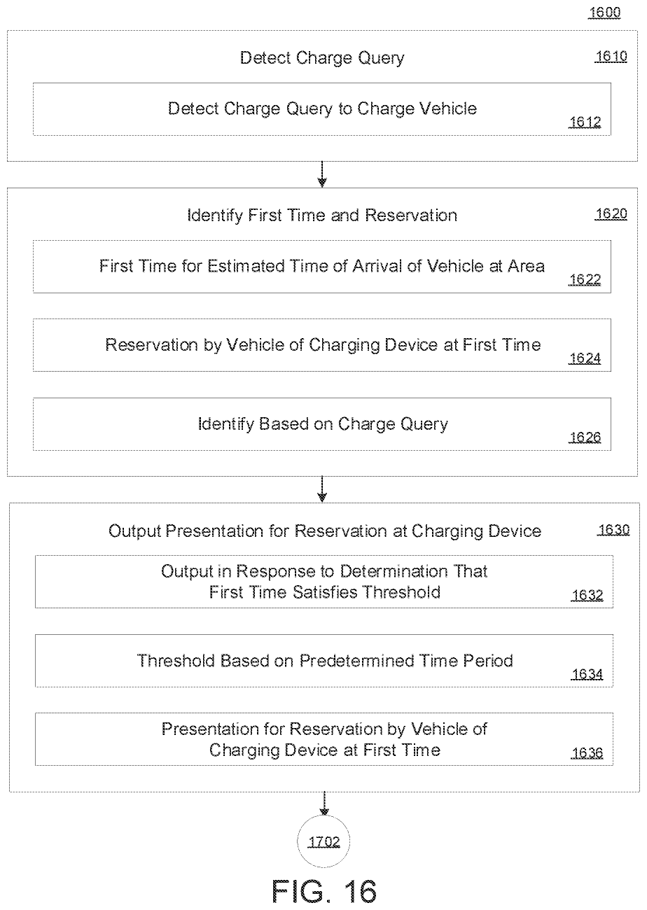

FIG. 16 depicts a method 1600 of location-aware and time-aware to coordination of indications at charging devices and electric vehicles, in accordance with present implementations. The system 100 can perform the method 1600. The method 1600 can include detecting a charge query. (Act 1610.) For example, the data processing system 102 can receive a reservation request from the vehicle 170 via the network. The reservation request can be encapsulated in a query transmitted in a format compatible with the data processing system 102. Detecting a charge query can include detecting a charge query to charge a vehicle. (Act 1612.) For example, the reservation request can identify a particular vehicle requesting charging by an identification number, vehicle identification number (VIN), user identity of an owner or user of the vehicle, or any combination thereof.

Subsequent to detecting a charge query, the method 1600 can include identifying a first time and reservation. (Act 1620.) For example, the data processing system 102 can extract a reservation request time comprising an absolute time or a relative time. An absolute time can include a particular timestamp or data and time, including “12:00 PM today.” A relative time can include a timestamp offset or a time in the future, including “one hour from now.” Identifying a first time and reservation can include identifying a first time for an estimated time of arrival of a vehicle at area. (Act 1622.) For example, the first time can be based on a distance between the vehicle and the charging area, and can be further based on traffic between the vehicle and the charging area along one or more routes therebetween. Identifying a first time and reservation can include identifying a reservation by a vehicle of a charging device at a first time. (Act 1624.) For example, a reservation request can include a request to charge at any available charging device at a charging are, or a request to charge at one or more particular charging devices in a charging area. Identifying a first time and reservation can include identifying a first time and reservation based on a charge query. (Act 1626.) For example, the first time and the reservation can be embedded within the query, or can reference data external to the query.

Subsequent to identifying a first time and reservation, the method 1600 can include outputting a presentation for a reservation at a charging device. (Act 1630.) For example, charging device can output a constant red light to indicate that a charging device is reserved and that activation is restricted to a particular vehicle. Outputting a presentation for a reservation at a charging device can include outputting a presentation in response to a determination that a first time satisfies a threshold. (Act 1632.) For example, the charging device can output the red color light after the data processing system 102 determines that the reservation is within a reservation lock time period. Outputting a presentation for a reservation at a charging device can include outputting a presentation in response to a determination that a first time satisfies a threshold based on a predetermined time period. (Act 1634.) For example, a charging device may only output a reservation indication in red within an hour of the reservation. Outputting a presentation for a reservation at a charging device can include outputting a presentation for a reservation by a vehicle of a charging device at a first time. (Act 1636.) For example, the charging device can output the reservation indication including red light upon receipt and processing of the query at the data processing system.

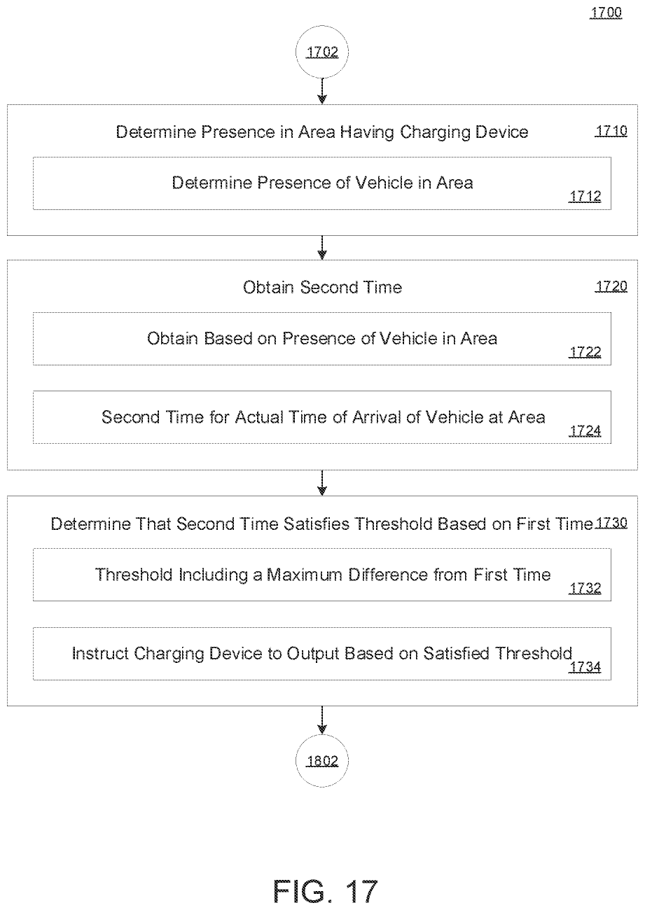

FIG. 17 depicts a method 1700 of location-aware and time-aware to coordination of indications at charging devices and electric vehicles further to the method of FIG. 16. The system 100 can perform the method 1700. Subsequent to outputting a presentation for a reservation at a charging device, the method 1700 can include determining a presence in an area having a charging device. (Act 1702, 1710.) For example, the data processing system can determine a location of a vehicle based on coordinates transmitted by the vehicle based on a Global Position System (GPS). Determining a presence in an area having a charging device can include determining a presence of a vehicle in an area having a charging device. (Act 1712.) For example, the data processing system can determine that a Global Position System (GPS) location of a vehicle is within a geofence corresponding to a collection of GPS coordinates.

Subsequent to determining a presence in an area having a charging device, the method 1700 can include obtaining a second time. (Act 1712, 1710.) For example, the second time can correspond to a time that the location of the vehicle is within the geofence corresponding to the charging area. Obtaining a second time can include obtaining a second time based on a presence of a vehicle in the area. (Act 1722.) For example, the second time can correspond to a time that the location of the vehicle reaches the geofence corresponding to the charging area. Obtaining a second time can include obtaining a second time corresponding to an actual time of arrival of a vehicle in the area. (Act 1724.) For example, the data processing system 102 can continuously receive location data or coordinates from a vehicle and determine a timestamp at which the vehicle reaches a boundary of the geofence defining the charging area.

Subsequent to obtaining a second time, the method 1700 can include determining that a second time satisfies a threshold based on a first time. (Act 1730.) For example, a threshold can correspond to a grace period after the reservation request time. Determining that a second time satisfies a threshold based on a first time can include determining that a second time satisfies a threshold including a maximum difference from a first time. (Act 1732.) For example, the data processing system can subtract a timestamp for the time of arrival of the vehicle from a timestamp comprising the sum of the reservation time and the timestamp offset corresponding to the grace period. Determining that a second time satisfies a threshold based on a first time can include instructing a charging device to output a presentation based on a determination that a threshold is satisfied. (Act 1734.) For example, the charging device can present a destination indication.

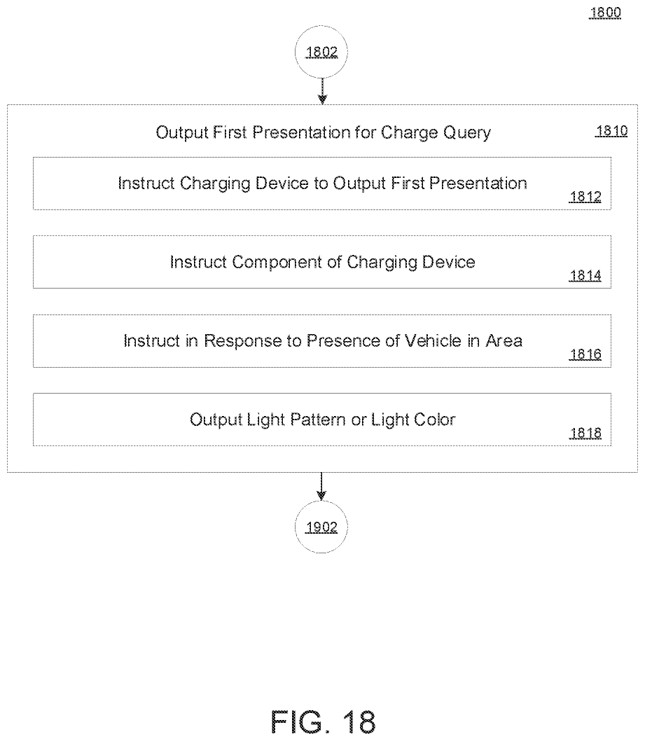

FIG. 18 depicts a method 1800 of location-aware and time-aware to coordination of indications at charging devices and electric vehicles further to the method of FIG. 17. The system 100 can perform the method 1800. Subsequent to determining that a second time satisfies a threshold based on a first time, the method 1800 can include outputting a first presentation corresponding to a charge query. (Act 1802, 1810.) For example, a first presentation can correspond to a visual indication at a charging device to assist navigation from an entrance 712 of a charging area to a charging device 730 or 320 at locations 1202 or 1302. Outputting a first presentation corresponding to a charge query can include instructing a charging device to output a first presentation. (Act 1812.) For example, the charging device can output violet light. Outputting a first presentation corresponding to a charge query can include instructing a component of a charging device. (Act 1814.) For example, the indication processor 130 can instruct the indication device 192. Outputting a first presentation corresponding to a charge query can include instructing a charging device in response to a presence of a vehicle in an area. (Act 1816.) For example, the charging device can begin to display a destination indication upon entry of the vehicle in the charging area 710 by the entrance 712. Outputting a first presentation corresponding to a charge query can include outputting a light pattern or light color. (Act 1818.) For example, the charging device can output a color matching only the color present at the vehicle 170 and distinct from any color concurrently presented at any other vehicle on a navigation path in the charging area.

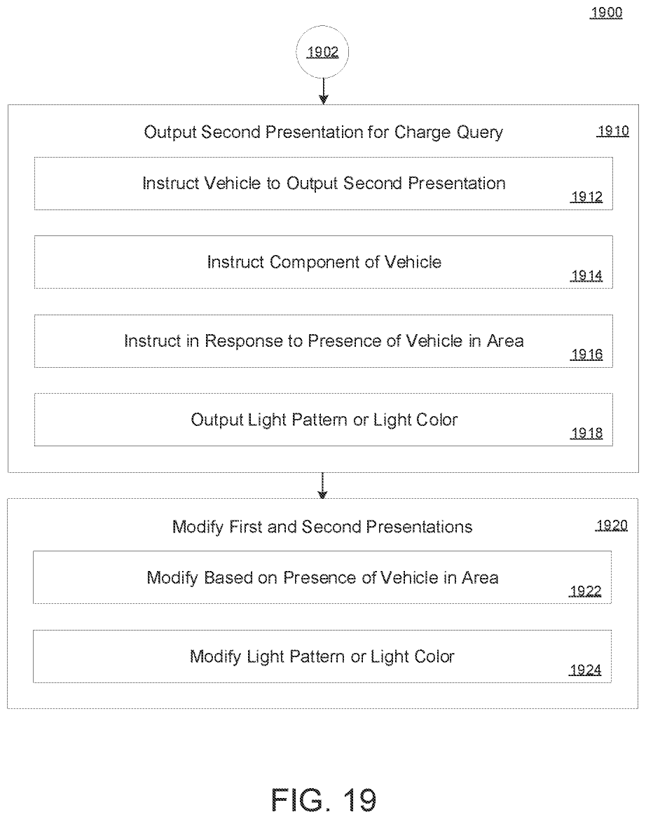

FIG. 19 depicts a method 1900 of location-aware and time-aware to coordination of indications at charging devices and electric vehicles further to the method of FIG. 18. The system 100 can perform the method 1900. Subsequent to outputting a first presentation corresponding to a charge query, the method 1900 can include outputting a second presentation corresponding to a charge query. (Act 1902, 1910.) For example, a second presentation can correspond to a visual indication at a vehicle to assist navigation from an entrance 712 of a charging area to a charging device 730 or 320 at locations 1202 or 1302. Outputting a second presentation corresponding to a charge query can include instructing a vehicle to output a second presentation. (Act 1912.) For example, the vehicle can output violet light. Outputting a second presentation corresponding to a charge query can include instructing a component of a vehicle. (Act 1914.) For example, one or more of cabin lights, floor light, headlights, or fog lights can be activated to emit a particular color or pattern of light. Outputting a second presentation corresponding to a charge query can include instructing a vehicle in response to a presence of a vehicle in an area. (Act 1916.) For example, the vehicle can begin to display a destination indication upon entry of the vehicle in the charging area 710 by the entrance 712. Outputting a second presentation corresponding to a charge query can include outputting a light pattern or light color. (Act 1918.) For example, the vehicle can output a color matching only the color present at the charging device to which it is linked based on the query, and distinct from any color concurrently presented at any other vehicle on a navigation path in the charging area.

Subsequent to outputting a second presentation corresponding to a charge query, the method 1900 can include modifying one or more of a first presentation and a second presentation. (Act 1920.) For example, a brightness or frequency of modulation can be increased or decreased respectively in response to the vehicle moving closer or farther from the charging device to which it is linked. Modifying one or more of a first presentation and a second presentation can include modifying one or more of a first presentation and a second presentation based on a presence of a vehicle in an area. (Act 1922.) For example, first and second presentations can be activated immediately when a vehicle enters the charging area. Modifying one or more of a first presentation and a second presentation can include modifying one or more of a light pattern and a light color. (Act 1924.) For example, a light pattern can be modified from a pulsating to a flashing pattern.

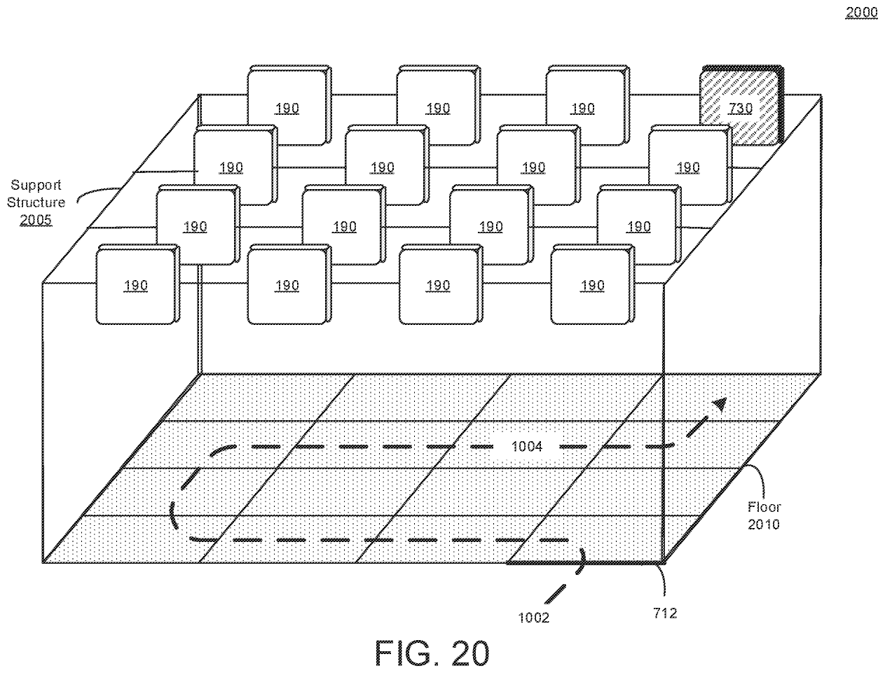

FIG. 20 depicts a charging area in accordance with present implementations. As illustrated by way of example in FIG. 20, an example charging area 2100 can include a support structure 2005 including a plurality of the charging devices 190 and 730 disposed over a floor 2010. The support structure 2005 can include a scaffolding or the like to house at least partially one or more of the charging devices 190 and 730. The floor 2010 can include the entrance 712, the entry path 1002, and the navigation path 1004. The charging devices 190 and 730 can be located, for example, on the floor 2010 and are not limited to placement at the support structure 2005 or over the floor 2010.

The charging devices 190 can be arranged in accordance with a geometric pattern or shape, for example, and can be activated individually, in subsets, or in particular groups to provide illumination in accordance with a visual pattern with respect to the floor 2010 or the navigation path 1004, for example. The visual pattern can correspond to illumination of one or more light-emitting elements of the charging devices, and can include one or more static patterns that remain stable over time or dynamic patterns that change over time. The patterns can correspond to one or more geometric patterns or shapes, and can be statically or dynamically illuminated to correspond to one or more geometric patterns or shapes as discussed herein.

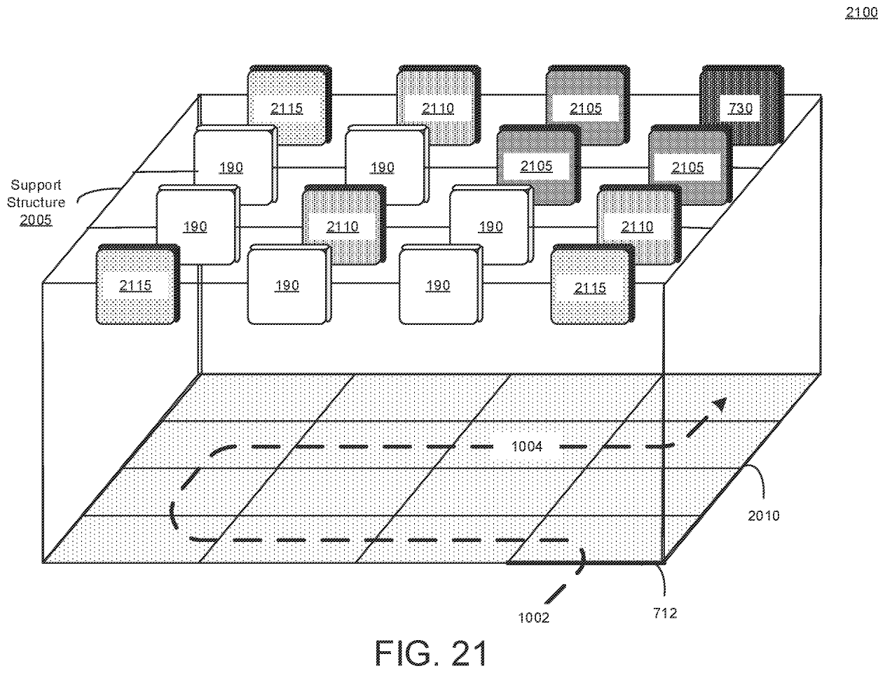

FIG. 21 depicts a charging area in accordance with present implementations. As illustrated by way of example in FIG. 21, an example charging area 2100 can include the support structure 2005 including the plurality of the charging devices 190 and 730 disposed over the floor 2010. Various ones of the charging devices 190 can be illuminated in accordance with illuminations 2105, 2110 and 2115.

The charging devices 190 can provide indications via one or more of the illuminations 2105, 2110 and 2115 to guide a vehicle 170 toward the charging device 730. For example, the support structure 2005 can include various illuminations generated by the charging devices 190 to illuminate a direction toward the charging device 730. For example, the illuminations 2105, 2110 and 2115 can be presented in one or more line patterns extending from or toward the charging device 730. For example, a subset of the illuminations 2105, 2110 and 2115 can be activated to illuminate a line between the charging device 730 and a charging device at a corner opposite to the charging device 730. For example, a subset of the illuminations 2105, 2110 and 2115 can be activated sequentially to illuminate a moving line or a sequence of illuminated points traveling to or converging on the charging device 730 from a charging device at a corner opposite to the charging device 730.

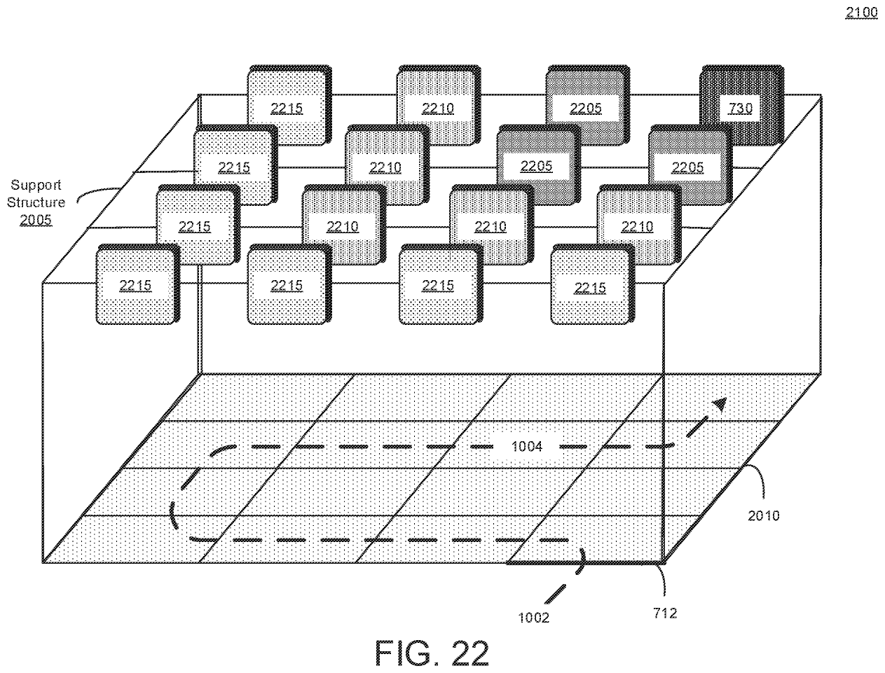

FIG. 22 depicts a charging area in accordance with present implementations. As illustrated by way of example in FIG. 22, an example charging area 2200 can include the support structure 2005 including the plurality of the charging devices 190 and 730 disposed over the floor 2010. Various ones of the charging devices 190 can be illuminated in accordance with illuminations 2205, 2210 and 2215.

The charging devices 190 can provide indications via one or more of the illuminations 2205, 2210 and 2215 to guide a vehicle 170 toward the charging device 730. For example, the support structure 2005 can include various illuminations generated by the charging devices 190 to illuminate a portion of the floor including the charging device 730. For example, the illuminations 2205, 2210 and 2215 can be presented in one or more “L” patterns including intersecting line patterns at least partially enclosing the charging device 730. For example, a subset of the illuminations 2205, 2210 and 2215 can be activated to illuminate an L pattern at least partially enclosing the charging device 730. For example, a subset of the illuminations 2205, 2210 and 2215 can be activated sequentially to illuminate a sequence of L patterns of decreasing size traveling to or converging on the charging device 730. For example, all charging devices with the illumination 2215 can be activated for a particular time period, and then deactivated. Subsequent to the deactivation of the charging devices with the illumination 2215, the charging devices with the illumination 2210 can be activated for a particular time period, and then deactivated. Subsequent to the deactivation of the charging devices with the illumination 2210, the charging devices with the illumination 2205 can be activated for a particular time period, and then deactivated. The sequence of activation and deactivation can continue or repeat in any order, including the example order above.

Some of the description herein emphasizes the structural independence of the aspects of the system components or groupings of operations and responsibilities of these system components. Other groupings that execute similar overall operations are within the scope of the present application. Modules can be implemented in hardware or as computer instructions on a non-transient computer readable storage medium, and modules can be distributed across various hardware or computer based components.

The systems described above can provide multiple ones of any or each of those components and these components can be provided on either a standalone system or on multiple instantiation in a distributed system. In addition, the systems and methods described above can be provided as one or more computer-readable programs or executable instructions embodied on or in one or more articles of manufacture. The article of manufacture can be cloud storage, a hard disk, a CD-ROM, a flash memory card, a PROM, a RAM, a ROM, or a magnetic tape. In general, the computer-readable programs can be implemented in any programming language, such as LISP, PERL, C, C++, C #, PROLOG, or in any byte code language such as JAVA. The software programs or executable instructions can be stored on or in one or more articles of manufacture as object code.

Example and non-limiting module implementation elements include sensors providing any value determined herein, sensors providing any value that is a precursor to a value determined herein, datalink or network hardware including communication chips, oscillating crystals, communication links, cables, twisted pair wiring, coaxial wiring, shielded wiring, transmitters, receivers, or transceivers, logic circuits, hard-wired logic circuits, reconfigurable logic circuits in a particular non-transient state configured according to the module specification, any actuator including at least an electrical, hydraulic, or pneumatic actuator, a solenoid, an op-amp, analog control elements (springs, filters, integrators, adders, dividers, gain elements), or digital control elements.

The subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatuses. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. While a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices include cloud storage). The operations described in this specification can be implemented as operations performed by a data processing apparatus on data stored on one or more computer-readable storage devices or received from other sources.

The terms “computing device”, “component” or “data processing apparatus” or the like encompass various apparatuses, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, app, script, or code) can be written in any form of programming language, including compiled or interpreted languages, declarative or procedural languages, and can be deployed in any form, including as a stand-alone program or as a module, component, subroutine, object, or other unit suitable for use in a computing environment. A computer program can correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatuses can also be implemented as, special purpose logic circuitry, e.g., an FPGA (field programmable gate array) or an ASIC (application specific integrated circuit). Devices suitable for storing computer program instructions and data can include non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

The subject matter described herein can be implemented in a computing system that includes a back end component, e.g., as a data server, or that includes a middleware component, e.g., an application server, or that includes a front end component, e.g., a client computer having a graphical user interface or a web browser through which a user can interact with an implementation of the subject matter described in this specification, or a combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While operations are depicted in the drawings in a particular order, such operations are not required to be performed in the particular order shown or in sequential order, and all illustrated operations are not required to be performed. Actions described herein can be performed in a different order.

Having now described some illustrative implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

For example, descriptions of positive and negative electrical characteristics may be reversed. Elements described as negative elements can instead be configured as positive elements and elements described as positive elements can instead by configured as negative elements. For example, elements described as having first polarity can instead have a second polarity, and elements described as having a second polarity can instead have a first polarity. Further relative parallel, perpendicular, vertical or other positioning or orientation descriptions include variations within +/−10% or +/−10 degrees of pure vertical, parallel or perpendicular positioning. References to “approximately,” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

What is claimed is:

1. A system, comprising:
a data processing system comprising one or more processors, coupled to memory, to:
detect a charge query to charge a vehicle;
determine a presence of the vehicle in an area having a charging device;
instruct, in response to the presence of the vehicle in the area, a component of the charging device to output a first presentation indicative of the charge query; and
instruct, in response to the presence of the vehicle in the area, a component of the vehicle to output a second presentation corresponding to the first presentation.

2. The system of claim 1, comprising the data processing system to:
identify, based on the charge query, a first time corresponding to an estimated time of arrival of the vehicle at the area, and a reservation by the vehicle of the charging device at the first time;
obtain, based on the presence of the vehicle in the area, a second time corresponding to an actual time of arrival of the vehicle at the area; and
instruct, in response to a first determination that the second time satisfies a threshold based on the first time, the component of the charging device to output the first presentation indicative of the reservation.

3. The system of claim 1, comprising:
the data processing system to instruct, in response to the presence of the vehicle in the area, a light emitting device integrated with the charging device to output the first presentation including at least one of a light color and a light pattern.

4. The system of claim 3, comprising:
the data processing system to instruct, in response to the presence of the vehicle in the area, a light emitting device integrated with the vehicle to output the second presentation including at least one of the light color and the light pattern.

5. The system of claim 4, comprising the data processing system to:
instruct, based on the presence of the vehicle in the area, the light emitting device integrated with the vehicle to modify the light pattern; and
instruct, based on the presence of the vehicle in the area, the light emitting device integrated with the charging device to modify the light pattern.

6. The system of claim 1, comprising the data processing system to:
instruct, in response to the presence of the vehicle in the area, a user interface integrated with the charging device to output the first presentation including at least one of video or audio; and
instruct, in response to the presence of the vehicle in the area, the user interface integrated with the vehicle to output the second presentation including at least one of video or audio personalized to an operator of the vehicle.

7. The system of claim 2, comprising the data processing system to:
instruct, in response to a second determination that the first time satisfies a second threshold based on a predetermined time period, the component of the charging device to output a third presentation indicative of a reservation by the vehicle of the charging device at the first time.

8. The system of claim 1, comprising the first presentation comprising a first light color and the second presentation comprising a second light color distinct from the first light color.

9. A vehicle, comprising:
a light emitting device, a non-transitory memory, and one or more processors to:
transmit a charge query to charge the vehicle;
determine a presence of the vehicle in an area having a charging device;
output, by the light emitting device in response to presence of the vehicle in the area, a first presentation indicative of the request and corresponding to a second presentation output by a component of the charging device.

10. The vehicle of claim 9, comprising the processors to:
transmit a parameter indicative of a reservation by the vehicle of the charging device at the first time and including an identifier of the vehicle, the area, and a first time corresponding to an estimated time of arrival of the vehicle at the area;
transmit, based on the area and a location corresponding to the vehicle, a second time corresponding to an actual time of arrival of the vehicle at the area;
output, by the light emitting device in response to a determination that the second time satisfies a threshold based on the first time, the first presentation.

11. The vehicle of claim 9, comprising the light emitting device to:
output, in response to the presence of the vehicle in the area, the first presentation including at least one of a first light color or a first light pattern that matches at least one of a second light color or a second light pattern comprising the second presentation.

12. The vehicle of claim 11, comprising:
the light emitting device to modify, based on the presence of the vehicle in the area, the first light pattern.

13. The vehicle of claim 9, comprising:
output, in response to the presence of the vehicle in the area, the first presentation including at least one of a first light color or a first light pattern that matches at least one of a second light color or a second light pattern comprising the second presentation;
the light emitting device to modify, based on the presence of the vehicle in the area, the first light pattern; and
the second light pattern modified to match the first light pattern.

14. The vehicle of claim 9, comprising a user interface to:
output, in response to the presence of the vehicle in the area, the first presentation including at least one of video or audio personalized to an operator of the vehicle.

15. A charging device, comprising:
a light emitting device, a non-transitory memory, and one or more processors to:
detect a charge query to charge a vehicle;
determine a presence of the vehicle in an area having the charging device; and
output, by the light-emitting device in response to a determination that a location of the vehicle corresponds to the area, the first presentation.

16. The charging device of claim 15, comprising the processors to:
generate, based on an identification of the vehicle, the area, a first time corresponding to an estimated time of arrival of the vehicle at the area, and a second time corresponding to an actual time of arrival of the vehicle at the area based on the area and a location corresponding to the vehicle, an instruction to output the first presentation; and
output, by the light-emitting device in response to a first determination that the second time satisfies a threshold based on the first time, the first presentation.

17. The charging device of claim 15, comprising the light emitting device to:
output, in response to the presence of the vehicle in the area, the first presentation including at least one of a light color or a light pattern,
the second presentation including at least one of the light color or the light pattern.

18. The charging device of claim 15, comprising:
the light emitting device to modify, based on the presence of the vehicle in the area and the location, the light pattern.

19. The charging device of claim 15, comprising:
a user interface to output, in response to the presence of the vehicle in the area, the first presentation including at least one of video or audio.

20. The charging device of claim 15, comprising:
the light emitting device to output, in response to a second determination that a first time satisfies a second threshold based on a predetermined time period, a third presentation indicative of a reservation by the vehicle of the charging device at the first time.
